(19) United States
(12) Patent Application Publication
(10) Pub. No.: US 2022/0138766 A1
(43) Pub. Date: May 5, 2022

(54) SYSTEMS, METHODS, AND APPARATUSES FOR IMPLEMENTING DATA COLLECTION, ANALYSIS, AND A REWARD SYSTEM FOR ZERO PLASTIC POLLUTION

(71) Applicant: Arizona Board of Regents on behalf of Arizona State University, Scottsdale, AZ (US)

(72) Inventors: Xuesong Zhou, Scottsdale, AZ (US); Xenia Zhao, Chandler, AZ (US)

(21) Appl. No.: 17/515,173

(22) Filed: Oct. 29, 2021

Related U.S. Application Data
(60) Provisional application No. 63/107,224, filed on Oct. 29, 2020.

(51) Int. Cl. G06Q 30/00; G06Q 30/02

(52) U.S. Cl. CPC G06Q 30/018; G06Q 30/0205

(57) ABSTRACT

In accordance with embodiments disclosed herein, there are provided herein systems, methods, and apparatuses for implementing data collection, analysis, and a reward system for zero plastic pollution. For instance, an analysis model is provided to find key performance indices including over-saturation of plastic in a region. According to a particular embodiment, a specially configured system having: a memory to store instructions; a processor to execute instructions stored in the memory; and stored logic within the memory that, when executed by the processor, causes the processor to perform operations including: receiving data from a plurality of sources regarding geographic-based plastics usage, each source choosing a level of geographical region specificity regarding the geographic-based plastics usage, encrypting the received data, analyzing an inflow and outflow rate of plastics usage for a geographic region based on the encrypted received data, and ranking the plastics usage of each of the plurality of sources, by industry. Other related embodiments are disclosed.

### CLAIM OF PRIORITY

This non-provisional U.S. Utility Patent Application is related to, and claims priority to the U.S. Provisional Patent Application No. 63/107,224, entitled “METHOD FOR DATA COLLECTION, ANALYSIS, AND A REWARD SYSTEM FOR ZERO PLASTIC POLLUTION,” filed Oct. 29, 2020, having Attorney Docket Number 37684.651P, the entire contents of which is incorporated herein by reference.

### GOVERNMENT RIGHTS AND GOVERNMENT AGENCY SUPPORT NOTICE

None.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the invention relate generally to a system to track the geographic plastic consumption data utilizing blockchain technology, and more particularly to systems, methods, and apparatuses for implementing data collection, analysis, and a reward system for zero plastic pollution. An analysis model is provided to find key performance indices including over-saturation of plastic in a region.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

There is currently very little data on the circulation of plastics geographically. There are few existing technologies that track the flow of plastic from source to sink, especially geographically. There are also few existing technologies that use a distributed database to store data. Moreover, existing solutions rely on a centralized system that is easily destabilized and cannot accurately predict plastic congestion in a region or project when plastic consumption will reach zero (0).

Problematically, the lack of available data has created problems for modeling plastic pollution, which prevents further study of the topic and solutions to the issue. As such, parties such as the government and private non-governmental organizations (NGOs) lack adequate data by which to drive decisions.

Greenpeace USA has developed a method to evaluate the plastic-friendliness of a store by the amount of packaging they use. However, this method is flawed and fails to address the problems noted above. Specifically, the lack of data and transparency within companies means that plastic packaging is vastly undercounted, leading to erroneous and often misleading information. Furthermore, Greenpeace USA has been controversial in the past with their partisan affiliations resulting in the evaluation process potentially lacking objectivity.

There is a need for a trusted data collection system that will satisfy projections for long-term planning and solutions which yields not only sufficient data but also overcomes the present lack of transparency and thus, provides accurate and trustable data upon which to make decisions.

The present state of the art may therefore benefit from the systems, methods, and apparatuses for implementing data collection, analysis, and a reward system for zero plastic pollution, as are described herein.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1 depicts a 2D map that relies on Hilbert's space filling curve to partition areas of land with little distortion, according to the described embodiments;

FIG. 2 shows a table demonstrating how the S2 grid system based on the Hilbert curve allows for varying levels of specificity, according to the described embodiments;

FIG. 3A depicts an exemplary architecture for the InterPlanetary File System (IPFS), as used in conjunction with the described embodiments;

FIG. 3B depicts accessing data using an interplanetary file system in accordance with described embodiments;

FIG. 4A depicts an exemplary computing architecture upon which the platform for zero plastic pollution 400 may operate, in accordance with described embodiments;

FIG. 4B depicts an exemplary DLT or blockchain architecture 401, with additional detail of a blockchain standard or protocol block 450, in accordance with described embodiments;

FIG. 5 depicts the S2 Geometry library for spherical geometry and the interplanetary file system (IPFS) to create a discrete global grid, to build a geographic database, in accordance with the described embodiments;

FIG. 6 plots λ(t) and M(t) (inflow lambda and outflow mu) on a time-number graph in accordance with the described embodiments. As is depicted here, both λ(t) and M(t) are plotted on a time-number graph;

FIG. 7 plots, at time t_1 a queue begins to form, at t_2 a queue length is longest, and at t_3 a queue dissipates, in accordance with the described embodiments;

FIG. 8 plots Qmax (Q(t)) as a function of time, in accordance with the described embodiments;

FIG. 9 plots both A(t) and D(t) as a function of time, where Q is equal to A(t) minus D(t), in accordance with the described embodiments;

FIG. 10 illustrates a diagrammatic representation of a machine 1000 in the exemplary form of a computer system, in accordance with one embodiment; and

FIGS. 11A-11B depicts a flow diagram illustrating a method for implementing data collection, analysis, and a reward system for zero plastic pollution, in accordance with disclosed embodiments.

### DETAILED DESCRIPTION

Described herein are systems, methods, and apparatuses for implementing data collection, analysis, and a reward system for zero plastic pollution.

Embodiments of the invention provide a distributed database for storing plastic data based on geographic self-reporting by individuals and organizations who can choose their level of specificity, which leads to trusted data. The database capitalizes on InterPlanetary File System (IPFS) blockchain technology to encrypt the data, which makes it more reliable and resilient. The embodiments further analyze inflow and outflow rates of plastic to determine oversaturation within a system and when that oversaturation will become 0. Embodiments apply the data to create an incentive system called EcoMetric to rank the plastic friendliness of different companies by industry category. Embodiments also utilize the analysis to develop goals for plastic consumption. Embodiments refer to the ultimate goal P0 (P-zero) for plastic zero, and incremental goals such as P5 and P25.

Disclosed embodiments specifically include a system specifically configured to track, estimate, and report geographic plastic consumption data, capitalizing on blockchain technology, as well as incentivize the reduction of plastic waste into the natural environments. In support of such systems, an analysis engine is provided which captures and analyzes non-intuitive data sources to find key performance indices such as the oversaturation of plastic in a region and the estimated time to reach 0 oversaturation. Still further, the system provides a reward system incentivising the reduction of plastic usage, by ranking companies and other market participants according to their respective environmental friendliness. Because the system utilizes and promotes more trusted data that is useful to industry vendors and communities, such stakeholders are more likely to participate which thus in turn promotes improved environmental conditions and drives compliance with the ultimate goal of P0 plastic pollution.

Geographic data has more applications for researchers and policymakers that want to use it for decision making. Furthermore, the degree of freedom in data reporting (based on an S2 geometric grid) allows for privacy on the behalf of the consumer which leads to more trusted data. Additionally, a distributed database according to the described embodiments is uniquely more reliable than one that uses a centralized system. Embodiments further use a built-in data mining method that generates relevant outputs that can help researchers set goals for plastic consumption. Finally, an “EcoMetric”, according to embodiments, takes into consideration the industry that each company is in, which makes more companies willing to adopt and participate in the program. In summary, advantages of embodiments of the invention include more trusted data that is useful to industry vendors and communities, a built-in data mining system that gives relevant outputs, and a reward system that businesses are more likely to adopt.

Embodiments of the invention may be implemented as an open source project, allowing for more transparency. Open source databases have numerous benefits, including flexibility, speed, and cost effectiveness. Furthermore, data is more trusted due to the degree of freedom in geographic reporting and the verification methods.

Embodiments of the invention may be highly useful and desired by researchers and city planners in many places. Data is sorely lacking, and the described embodiments would provide a reliable source for such data. Furthermore, consumers are increasingly inclined to choose environmental-friendly companies, and methods according to the described embodiments would help consumers do so.

In the following description, numerous specific details are set forth such as examples of specific systems, languages, components, etc., in order to provide a thorough understanding of the various embodiments. It will be apparent, however, to one skilled in the art that these specific details need not be employed to practice the embodiments disclosed herein. In other instances, well-known materials or methods have not been described in detail in order to avoid unnecessarily obscuring the disclosed embodiments.

In addition to various hardware components depicted in the figures and described herein, embodiments further include various operations described below. The operations described in accordance with such embodiments may be performed by hardware components or may be embodied in machine-executable instructions, which may be used to cause a specialized or special-purpose processor programmed with the instructions to perform the operations. Alternatively, the operations may be performed by a combination of hardware and software.

Embodiments also relate to an apparatus for performing the operations disclosed herein. This apparatus may be specially constructed for the required purposes, or it may be a specially configured computer selectively activated or reconfigured by a computer program stored in the computer. Such a computer program may be stored in a computer-readable storage medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various specially configured computing systems may be used with programs in accordance with the teachings herein, or it may prove convenient to construct a more specialized apparatus to perform the required method steps. The required structure for a variety of these systems will appear as set forth in the description below. In addition, embodiments are not described with reference to any particular programming language. It will be appreciated that a variety of programming languages may be used to implement the teachings of the embodiments as described herein.

Embodiments may be provided as a computer program product, or software, that may include a machine-readable medium having stored thereon instructions, which may be used to program a computer system (or other electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.), a machine (e.g., computer) readable transmission medium (electrical, optical, acoustical), etc.

Any of the disclosed embodiments may be used alone or together with one another in combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

In addition to various hardware components depicted in the figures and described herein, embodiments further include various operations which are described below. The operations described in accordance with such embodiments may be performed by hardware components or may be embodied in machine-executable instructions, which may be used to cause a special-purpose processor programmed with the instructions to perform the operations. Alternatively, the operations may be performed by a combination of hardware and software, including software instructions that perform the operations described herein via memory and one or more processors of a computing platform.

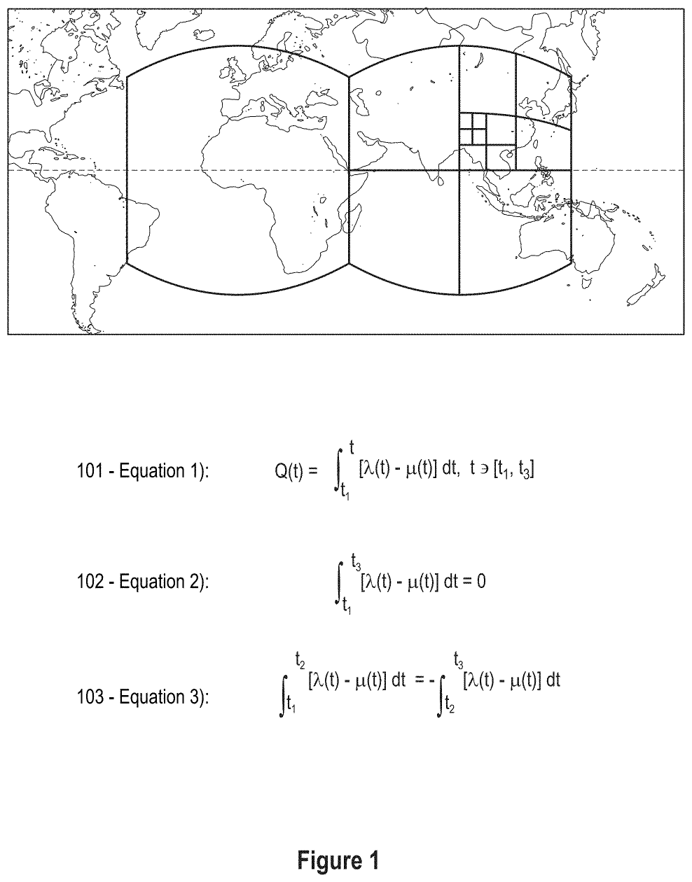

FIG. 1 depicts a 2D map that relies on Hilbert's space filling curve to partition areas of land with little distortion, according to the described embodiments.

In accordance with described embodiments, data is collected from spatially distributed users at different resolutions. For instance, as shown here, an exemplary framework for splitting up regions geographically may be based on the S2Geometry grid system, in which a discrete global grid converts the Earth's 3D sphere into a 2D map and relies on Hilbert's space filling curve to partition areas of land with little distortion.

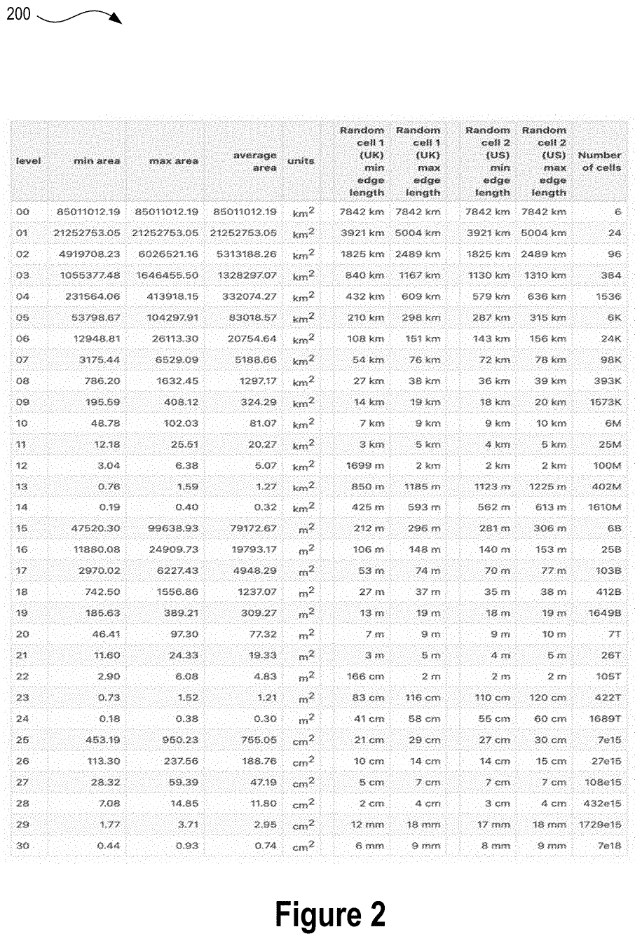

FIG. 2 shows a table demonstrating how the S2 grid system based on the Hilbert curve allows for varying levels of specificity.

According to described embodiments, one novel feature is the ability to preserve privacy using a suitable resolution. For instance, as is depicted at the table shown here, one of the features of the S2 grid system is that the Hilbert curve allows for varying levels of specificity, from an area of 10A7 kmA2 at level 00 all the way down to 10A-2 cmA2 at level 30.

As shown, each level fills a different amount of space for each S2 cell, which in turn allows for hierarchical levels of specificity. This freedom may thus be exploited for data collection. For instance, when an entity reports geographical data, they can choose the S2 cells from which they report, which allows for more privacy when compared to exact longitude and latitude, leading to more trusted data.

For the purposes of data that is useful for plastic pollution, levels 05 to 20 may be utilized as the bounds, according to a particular embodiment. For example, these levels may be chosen for the state of Arizona (295,254 kmA2) because the state falls under level 05 and the average apartment building (80 mA2) falls under level 20.

According to described embodiments, various actors report the amount of plastic that they handle every day. Such actors may include individuals, non-governmental organizations (NGOs), governments, retailers, manufacturers, and other businesses that handle plastics.

For example, a business that receives shipments of 1000 plastic bags per day may report such shipments at a specificity level of twenty-one (21). Similarly, a consumer that takes home five (5) plastic bags from the store would also report such receipt, for example, at a specificity level of twenty-three (23). For example, consider an end-consumer at Arizona State University-Tempe Campus. Such an end-consumer may report receipt of a plastic bag out of the west corner of Hayden Library (specificity level 20) or that they took the bag out of Arizona State University (specificity level 13), or out of the city of Phoenix (specificity level 08).

According to the described embodiments, isolated single source data is subsequently verified by comparing the single source data with multiple other data sources. According to certain embodiments, statistical analysis is further applied in which statistical outliers are identified and investigated in greater detail, thus leading to increasingly trusted data.

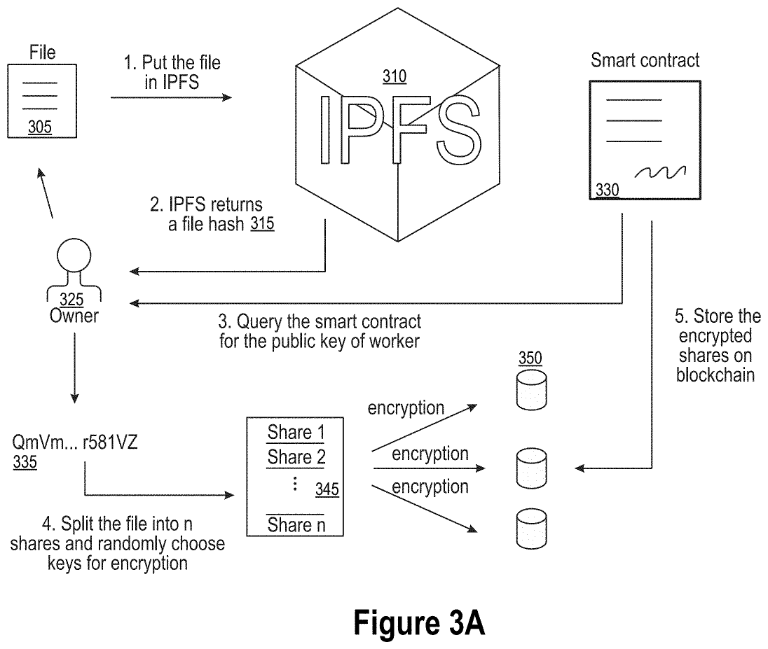

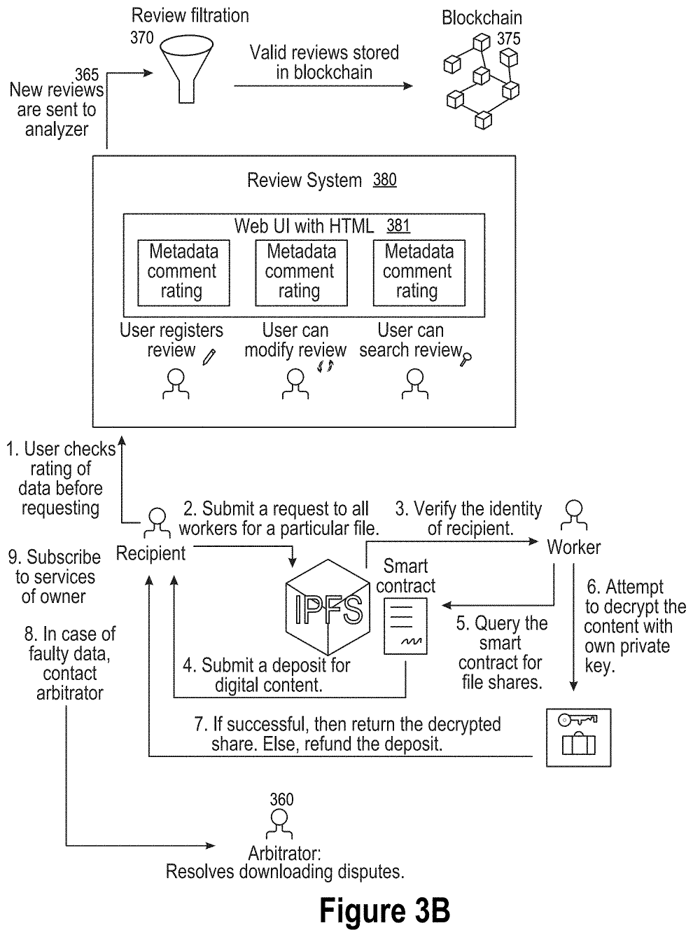

FIG. 3A depicts an exemplary architecture for the InterPlanetary File System (IPFS), as used in conjunction with the described embodiments.

The InterPlanetary File System (IPFS) is a protocol and peer-to-peer network for storing and sharing data in a distributed file system. The IPFS protocol uses content-addressing to uniquely identify each file in a global namespace connecting all computing devices. More particularly, the IPFS protocol allows users to host and receive content in a manner similar to BitTorrent. However, as opposed to a centrally located server, the IPFS protocol is built around a decentralized system of user-operators, each of whom possesses (e.g., persistently stores at that particular node) only a portion of the overall data, creating a resilient system of file storage and sharing. Any user in the network can serve a file by its content address, and other peers in the network can find and request that content from any node who has it using a distributed hash table (DHT).

As shown here, a file 305 may be placed into the IPFS 310 by an owner 325. Responsive to the file being placed, the IPFS returns a file hash 315 to the file owner. In certain instances, smart contract 330 validation may additionally be applied to files placed into the IPFS, for instance, to ensure appropriate form, completeness, a valid origination point, etc. The file owner 325 may also query the smart contract 330 for the public key of a worker, responsive to which the IPFS 310 returns the requested public key 335. Next, the file is split into n number of shares and the IPFS randomly selects keys for encryption, resulting in the multiple shares 345 depicted here. The encrypted shares are then pushed to the distributed repositories 350 (e.g., the various participants). According to certain embodiments, the encrypted shares stored upon the IPFS may take the form of assets stored onto a blockchain.

According to the described embodiments, use of the IPFS protocol is leveraged as a distributed system for data storage and information encryption. For instance, because the IPFS protocol provides a peer-to-peer file sharing system that capitalizes on a distributed network, the IPFS protocol is specifically utilized. However, other distributed file and data storage systems may also be used.

As shown here, peers in the network can request content from each other using a distributed hash table (DHT), which serves as a database of IDs for each individual unit of information. The distributed web seeks to make every client participate in content distribution and thus has several benefits, including resilience.

According to such embodiments, the quantity of plastic bags that enters or exits a region (as determined by the data described above) is stored as a file 305 on IPFS 310. Each file 305 is given a unique hash 315 that makes it easier to track. Over time, the IPFS 310 holds a large amount of information about the rate of plastic bag inflow or outflow in a region. After self-reporting by individuals, businesses, and NGOs, and other actors, distribution of the data is automatically performed by the IPFS protocol.

Moreover, because the data is public, it can be investigated further for accuracy. The data is thus highly credible and can be trusted by researchers. Such a distributed data system allows users to input blocks on their own, which makes it much easier to manage when compared to a centralized system. In related embodiments where the information distribution is implemented as an open source project, the data can also be accessed easily.

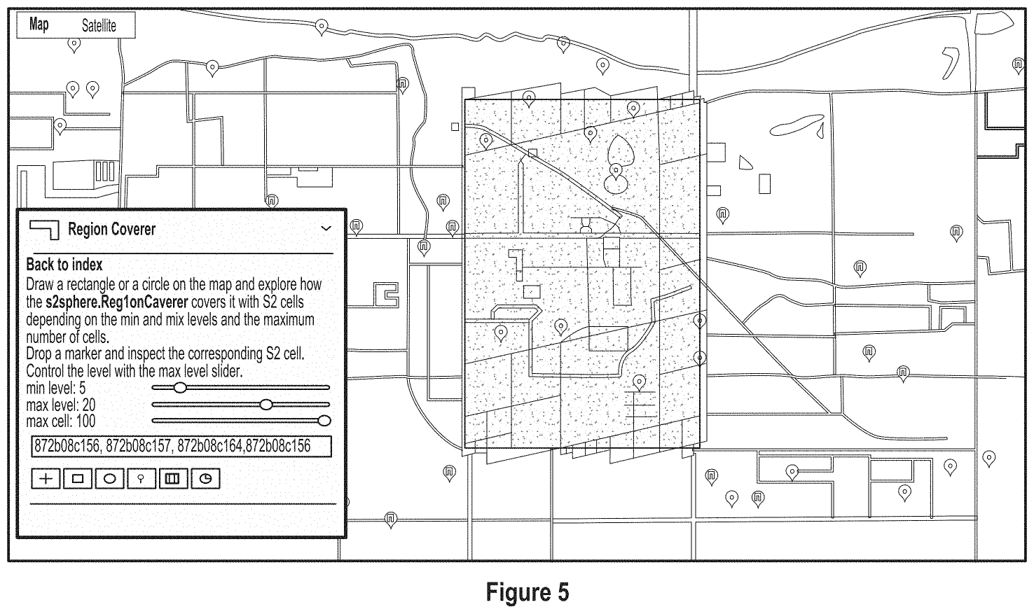

According to the described embodiments, data retrieval uses a global discrete unique ID. Due to the nature of the data, there are different geographical levels at which the data can be accessed. For instance, reference to FIG. 5 which is described in greater detail below, using the S2Geometry library and platform for spherical geometry and building on IPFS, embodiments create a discrete global grid to build a geographic database. Thus, data can be accessed on various temporal levels, i.e., rate of plastic bag distribution per day, per month, per year; or on various geographical levels, i.e., plastic bag use per facility, per state, per country.

FIG. 3B depicts accessing data using an interplanetary file system in accordance with described embodiments.

As shown here, a user may utilize the IPFS technology for accessing data. For instance, if someone would like to collect data for a particular location, such as Arizona State University-Tempe Campus, which is not a single cell, then its unique location ID can be a combination of multiple smaller S2 cells, as depicted in greater detail below with reference to FIG. 5.

Regardless of the data requested, a user may check the rating of data before requesting such data as shown at step “1”. Next, a requestor and potential recipient submits a request to all workers on the IPFS system specifying a particular file as shown at step “2”. Next, the smart contract executing at the IPFS or executing via the blockchain performs validation to verify the identity of the recipient and requestor, as shown at step “3”. Next the smart contract submits a deposit for the digital content which is then returned to the recipient, as shown at step “4”. Next, a worker node attempts to decrypt the content with its own private key as shown at step “6”. Then, if successful, the worker returns the decrypted share to the recipient, and if not successful, then the deposit is refunded, such as is shown at step “7”. In the event of any faulty data or other downloading dispute, then the request is transmitted to the arbiter 360 which is responsible for resolving disputes, as is shown at step “8”. Finally, the requestor and recipient may subscribe to services from the file owner as is shown at step “9”.

With such a structure, any new reviews are sent to the analyzer 365 and processed through review filtration 370 before permitting valid reviews to be stored onto the blockchain 375. According to such an embodiment, such a review system 380 includes a Web UI with HTML 381 as an interface which permits metadata comment ratings by multiple distinct users, each of whom may register to review, modify reviews, and search reviews.

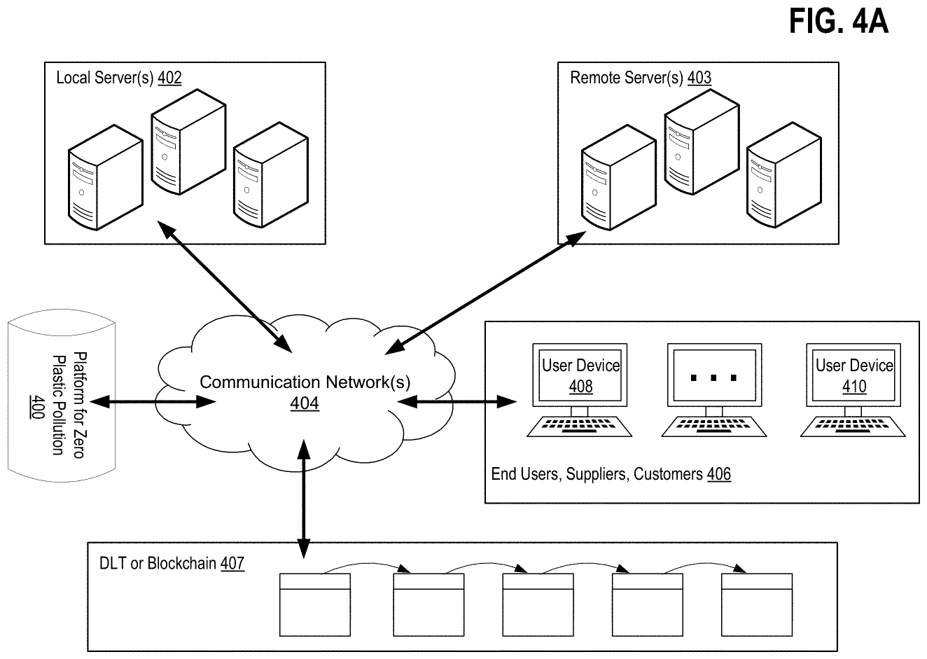

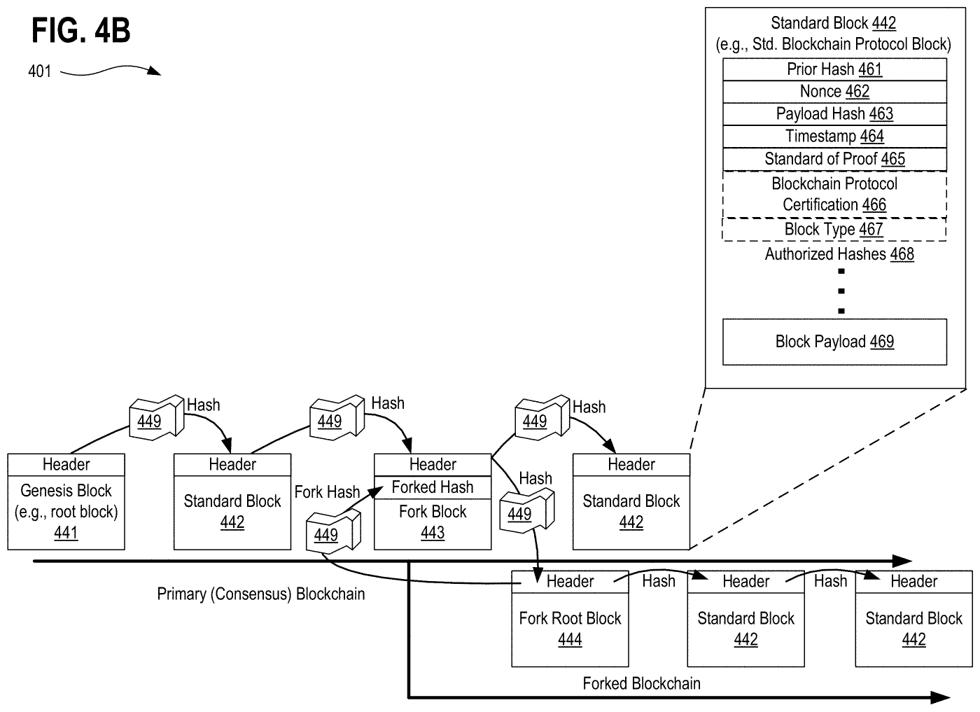

FIG. 4A depicts an exemplary computing architecture upon which the platform for zero plastic pollution 400 may operate, in accordance with described embodiments.

In particular, there is depicted here, both local servers 402 and remote servers 403 from which input data may automatically be retrieved and entered on behalf of the platform for zero plastic pollution 400 which may track localized data or remote data respectively on behalf of the platform for zero plastic pollution 400. Additionally, the platform for zero plastic pollution 400 provides functionality such as the Artificial Intelligence and Machine Learning functionality by which to implement the collection, analysis, and reword system procedures as described herein.

Still further depicted are the devices for end users, suppliers, customers, and other actors interacting with the system at element 406 which communicate with the platform for zero plastic pollution 400 and with the local and remote servers (402-403) via the communications network 404. For example, user device 408 may be located at a business, government department, manufacturer facility, or other stakeholder or entity location, etc., whereas user device 410 may be located at a kiosk or smartphone accessible to an end user, etc.

According to certain embodiments, data is stored and persisted utilizing IPFS, DLT, or other blockchain 407 technologies as is depicted here, and each of the various components such as local servers 402, remote servers 403, the platform for zero plastic pollution 400, and the end users, suppliers, and customers 406 may communicate with the IPFS, DLT or blockchain 407 technologies to store or retrieve data.

FIG. 4B depicts an exemplary DLT or blockchain architecture 401, with additional detail of a blockchain standard or protocol block 442, in accordance with described embodiments.

In particular, a blockchain standard or protocol block 442 is depicted here to be validated by, for example, a block validator of a participating node, with the blockchain protocol block including additional detail of its various sub-components, and certain optional elements which may be utilized in conjunction with the blockchain standard or protocol block 442 depending on the particular blockchain protocol being utilized via the platform for zero plastic pollution 400.

A blockchain is a continuously growing list of records, grouped in blocks, which are linked together and secured using cryptography. Each block typically contains a hash pointer 449 as a link to a previous block, a timestamp, and transaction data. By design, blockchains are inherently resistant to modification of the data. A blockchain system essentially is an open, distributed ledger that records transactions between two parties in an efficient and verifiable manner, which is also immutable and permanent. A distributed ledger (also called a shared or common ledger or referred to as distributed ledger technology (DLT)) is a consensus of replicated, shared, and synchronized digital data geographically spread across multiple nodes. The nodes may be located in different sites, countries, institutions, user communities, companies, departments, or application servers. There is no central administrator or centralized data storage.

Blockchain systems use a peer-to-peer (P2P) network of nodes, and consensus algorithms ensure replication of digital data across nodes. A blockchain system can be either public or private. Not all distributed ledgers necessarily employ a chain of blocks to successfully provide secure and valid achievement of distributed consensus. A blockchain is only one type of data structure considered to be a distributed ledger.

P2P computing or networking is a distributed application architecture that partitions tasks or workloads between peers. Peers are equally privileged, equally capable participants in an application that forms a peer-to-peer network of nodes. Peers make a portion of their resources, such as processing power, disk storage, or network bandwidth, directly available to other network participants, without the need for central coordination by servers or hosts. Peers are both suppliers and consumers of resources, in contrast to the traditional client-server model in which the consumption and supply of resources is divided. A peer-to-peer network is thus designed around the notion of equal peer nodes simultaneously functioning as both clients and servers to the other nodes on the network.

For use as a distributed ledger, a blockchain is typically managed by a peer-to-peer network collectively adhering to a protocol for validating new blocks. Once recorded, the data in any given block cannot be altered retroactively without the alteration of all subsequent blocks, which requires collusion of the network majority. In this manner, blockchains are secure by design and are an example of a distributed computing system with high Byzantine fault tolerance. Decentralized consensus has therefore been achieved with a blockchain. This makes blockchains potentially suitable for the recording of events, medical records, insurance records, and other records management activities, such as identity management, transaction processing, documenting provenance, or voting.

A blockchain database is managed autonomously using a peer-to-peer network and a distributed timestamping server. Records, in the form of blocks, are authenticated in the blockchain by collaboration among the nodes, motivated by collective self-interests. As a result, participants' uncertainty regarding data security is minimized. The use of a blockchain removes the characteristic of reproducibility of a digital asset. It confirms that each unit of value, e.g., an asset, was transferred only once, solving the problem of double spending.

Blocks in a blockchain each hold batches (“blocks”) of valid transactions that are hashed and encoded into a Merkle tree. Each block includes the hash of the prior block in the blockchain, linking the two. The linked blocks form a chain. This iterative process confirms the integrity of the previous block, all the way back to the first block in the chain, sometimes called a genesis block or a root block.

By storing data across its network, the blockchain eliminates the risks that come with data being held centrally and controlled by a single authority. The decentralized blockchain may use ad-hoc message passing and distributed networking. The blockchain network lacks centralized points of vulnerability that computer hackers can exploit Likewise, it has no central point of failure. Blockchain security methods include the use of public-key cryptography. A public key is an address on the blockchain. Value tokens sent across the network are recorded as belonging to that address. A private key is like a password that gives its owner access to their digital assets or the means to otherwise interact with the various capabilities that blockchains support. Data stored on the blockchain is generally considered incorruptible. This is where blockchain has its advantage. While centralized data is more controllable, information and data manipulation are common. By decentralizing it, blockchain makes data transparent to everyone involved.

Every participating node for a particular blockchain protocol within a decentralized system has a copy of the blockchain for that specific blockchain protocol. Data quality is maintained by massive database replication and computational trust. No centralized official copy of the database exists and, by default, no user and none of the participating nodes are trusted more than any other, although this default may be altered via certain specialized blockchain protocols as will be described in greater detail below. Blockchain transactions are broadcast to the network using software, via which any participating node, including the platform for zero plastic pollution 400 when operating as a node, receives such transaction broadcasts. Broadcast messages are delivered on a best effort basis. Nodes validate transactions, add them to the block they are building, and then broadcast the completed block to other nodes. Blockchains use various time-stamping schemes, such as proof-of-work, to serialize changes. Alternate consensus may be utilized in conjunction with the various blockchain protocols including, for example, proof-of-stake, proof-of-authority, and proof-of-burn, to name a few.

Open blockchains are more user-friendly than conventional traditional ownership records, which, while open to the public, still require physical access to view. Because most of the early blockchains were permissionless, there is some debate about the specific accepted definition of a so-called “blockchain,” such as, whether a private system with verifiers tasked and authorized (permissioned) by a central authority should be considered a blockchain. Proponents of permissioned or private chains argue that the term blockchain may be applied to any data structure that groups data into time-stamped blocks. These blockchains serve as a distributed version of multiversion concurrency control (MVCC) in databases. Just as MVCC prevents two transactions from concurrently modifying a single object in a database, blockchains prevent two transactions from spending the same single output in a blockchain.

An advantage to an open, permissionless, or public, blockchain network is that guarding against bad actors is not required and no access control is needed. This means that applications can be added to the network without the approval or trust of others, using the blockchain as a transport layer. Conversely, permissioned (e.g., private) blockchains use an access control layer to govern who has access to the network. In contrast to public blockchain networks, validators on private blockchain networks are vetted, for example, by the network owner, or one or more members of a consortium. They rely on known nodes to validate transactions. Permissioned blockchains also go by the name of “consortium” or “hybrid” blockchains. Today, many corporations are using blockchain networks with private blockchains, or blockchain-based distributed ledgers, independent of a public blockchain system.

In accordance with a particular embodiment, the blockchain standard or protocol block 442 depicted here defines a particular structure for how the fundamental blocks of any given blockchain protocol are organized.

The prior hash 461 is the result of a non-reversible mathematical computation using data from the prior block as the input. The prior hash 461 of the prior block (e.g., such as the hash of the genesis block 441 if the new block is the second block or the hash of a prior block corresponding to a previous standard block 442, depending on where in the chain the new block will be formed) is in turn utilized as data input from the n previous block(s) to form the non-reversible mathematical computation forming the prior hash for those respective blocks. For instance, according to one embodiment, the non-reversible mathematical computation utilized is a SHA256 hash function, although other hash functions may be utilized. According to such an embodiment, the hash function results in any change to data in the prior hash 461 of the prior block or any of the n previous blocks in the chain, causing an unpredictable change in the hash of those prior blocks, and consequently, invalidating the present or current blockchain protocol's standard block 442. Prior hash 461 creates the link between blocks, chaining them together to form the current blockchain protocol block or standard block 442.

When a block validator (e.g., executed by a participating node, etc.) calculates the prior hash 461 for the prior block, the hash must meet certain criteria defined by data stored as the standard of proof 465. Such criteria may be enforced by the execution of the smart contract as described above (refer to element 330 of FIG. 3A). For instance, in one embodiment, this standard of proof 465 is a number that the calculated hash must be less than. Because the output of the hashing function is unpredictable, it cannot be known before the hash is calculated what input will result in an output that is less than the standard of proof 465. The nonce 462 is used to vary the data content of the block, allowing for a large number of different outputs to be produced by the hash function in pursuit of an output that meets the standard of proof 465, thus making it exceedingly computationally expensive (and therefore statistically improbable) of producing a valid block with a nonce 462 that results in a hash value meeting the criteria of the standard of proof 465.

Payload hash 463 provides a hash of the data stored within the block payload 459 portion of the blockchain protocol block 442 and need not meet any specific standard of proof 465. However, the payload hash 463 is included as part of the input when the hash is calculated for the purpose of storing as the prior hash 461 for the next or subsequent block. Timestamp 464 indicates what time the blockchain protocol block or the blockchain “standard block” 442 was created within a certain range of error. According to certain blockchain protocol implementations provided via a blockchain services interface, the distributed network of users (e.g., blockchain protocol nodes) checks the timestamp 464 against their own known time and will reject any block having a timestamp 464 which exceeds an error threshold, however, such functionality is optional and may be required by certain blockchain protocols and not utilized by others.

The blockchain protocol certification 466 defines the required size and/or data structure of the block payload 469 as well as certifying compliance with a particular blockchain protocol implementation, and thus, certifies the blockchain protocol that the block subscribes to, as well as implements and honors the particular requirements and configuration options for the indicated blockchain protocol. The blockchain protocol certification 466 may also indicate a version of a given blockchain protocol and the blockchain protocol may permit limited backward and forward compatibility for blocks before nodes will begin to reject new blockchain protocol blocks for non-compliance.

Block type 467 is optional depending on the particular blockchain protocol utilized. Where required for a specific blockchain protocol, a block type 467 must be indicated as being one of an enumerated list of permissible block types 467. Certain blockchain protocols use multiple different block types 467, all of which may have varying payloads, but have a structure which is known a priori according to the blockchain protocol utilized, the declared block type 467, and the blockchain protocol certification 466 certifying compliance with such requirements. Non-compliance or an invalid block type or an unexpected structure or payload for a given declared block type 467 will result in the rejection of that block by network nodes.

Where a variable-sized block payload 469 is utilized, the block type 467 may indicate permissibility of such a variable-sized block payload 469 as well as indicate the index of the first byte in the block payload 469 and the total size of the block payload 469. The block type 467 may be utilized to store other information relevant to the reading, accessing, and correct processing and interpretation of the block payload 469.

Block payload 469 data stored within the block may relate to any number of a wide array of transactional data depending on the particular implementation and blockchain protocol utilized, including payload information related to, for example, financial transactions, ownership information, data access records, document versioning, medical records, voting records, compliance and certification, educational transcripts, purchase receipts, digital rights management records, or literally any kind of data that is storable via a payload of a blockchain protocol block 450, which is essentially any data capable of being digitized. Depending on the particular blockchain protocol chosen, the payload size may be a fixed size or a variable size, which in either case, will be utilized as at least part of the input for the hash that produces the payload hash 463.

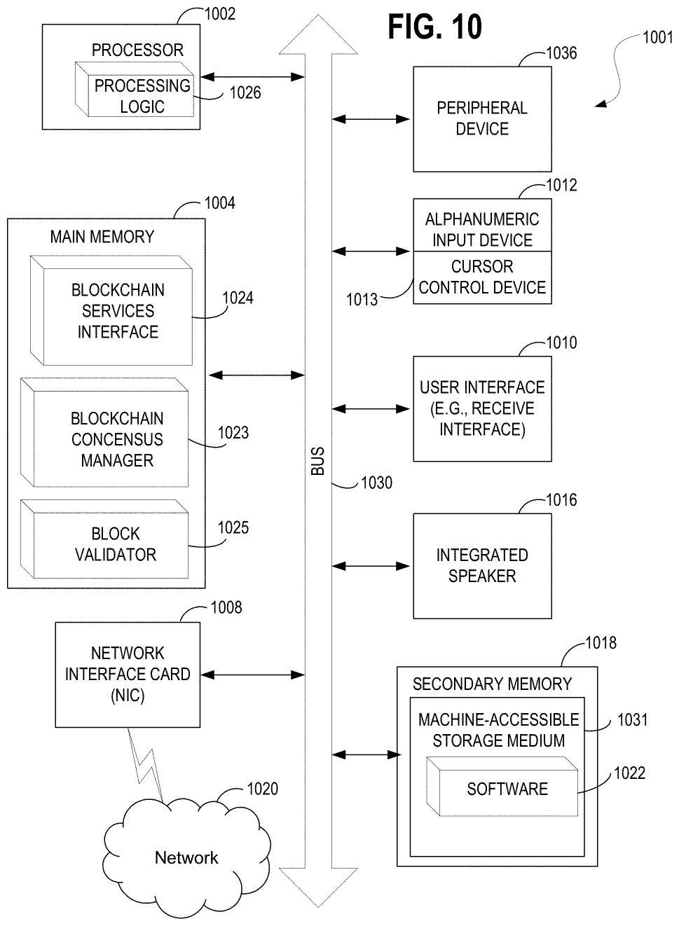

Various standard of proofs 465 may be utilized pursuant to the particular blockchain protocol chosen, such as proof of work, hash value requirements, proof of stake, a key, or some other indicator such as a consensus, or proof of consensus. Where consensus-based techniques are utilized, a blockchain consensus manager may provide consensus management on behalf of certain participating nodes or on behalf of the platform for zero plastic pollution (refer again to element 400 of FIG. 4A), however, the platform 400 may be operating only as one of many nodes for a given blockchain protocol which is accessed by the platform for zero plastic pollution 400 via, for example, a blockchain services interface (refer to element 1024 at FIG. 10). Such a standard of proof 465 may be applied as a rule that requires a hash value to be less than the proof standard, more than the proof standard, or may require a specific bit sequence (such as 10 zeros, or a defined binary sequence) or a required number of leading or trailing zeroes (e.g., such as a hash of an input which results in 20 leading or trailing zeros, which is computationally infeasible to provide without a known valid input).

The hash algorithms used for the prior hash 461, the payload hash 463, or the authorized hashes 449 may all be of the same type or of different types, depending on the particular blockchain protocol implementation. For instance, permissible hash functions include MD5, SHA-1, SHA-224, SHA-256, SHA-384, SHA-515, SHA-515/224, SHA-515/256, SHA-3, or any suitable hash function resistant to pre-image attacks. There is also no requirement that a hash is computed only once. The results of a hash function may be reused as inputs into another or the same hash function again multiple times in order to produce a final result.

Further depicted is a forked blockchain, branching from the primary blockchain (e.g., a consensus blockchain) which begins with a genesis block 441 (sometimes called a root block) followed by a series of standard blocks 462, each having a header which is formed based at least in part from a hash of the header of the block which precedes it. There is additionally depicted the forked blockchain formed with the initial fork root block 444, followed by then a series of standard blocks 442. Because each block in the blockchain contains a hash of the immediately preceding block stored in the previous hash, a link going back through the chain from each block is effectively created via the blockchain and is a key component to making it prohibitively difficult or computationally infeasible to maliciously modify the chain.

As depicted, the primary blockchain includes a single fork which is originating from the fork block 443. As shown here, the genesis block 441 is a special block that begins the primary blockchain and is different from the other blocks because it is the first block in the primary blockchain and therefore, cannot by definition, include a hash of any previous block. The genesis block 441 marks the beginning of the primary blockchain for the particular blockchain protocol being utilized. The blockchain protocol governs the manner by which the primary blockchain grows, what data may be stored within, how and when forked blockchains are created, as well as the manner by which the validity of any block and any chain may be verified via a block validator or any other participating network node of the blockchain pursuant to the rules and requirements set forth by the blockchain protocol certification 466 which is embedded within the genesis block 441 and then must be certified to and complied with by every subsequent block in the primary blockchain or any forked blockchain.

The blockchain protocol certification 466 inside each block in the genesis chain defines the default set of rules and configuration parameters that allows for the creation of forks and the modification of rules and configuration parameters in those forks, if any. Some blockchain protocol implementations permit no variation or non-compliance with the default set of rules as established via the blockchain protocol certification 466 and therefore, any fork will be the result of pending consensus for multiple competing potentially valid primary blockchains. Once consensus is reached (typically after one or two cycles and new block formations) then the branch having consensus will be adopted and the fork truncated, thus returning to a single primary consensus blockchain. Conversely, in other implementations, a forked blockchain may permissibly be created and continue to exist indefinitely alongside the primary blockchain, so long as the forked blockchain complies with the blockchain protocol certification 466 and permissible variation of rules and configuration parameters for a forked blockchain within that blockchain protocol.

Fork block 443 anchors the forked blockchain to the primary blockchain such that both the primary blockchain and the forked chain are considered valid and permissible chains where allowed pursuant to the blockchain protocol certification 466. Normally, in a blockchain, all non-consensus forks are eventually ignored or truncated and thus considered invalid except for the one chain representing the longest chain having consensus. Nevertheless, the fork block 443 expands beyond the conventional norms of prior blockchain protocols by operating as and appearing as though it is a standard block 442, while additionally including a reference to a fork hash 449 identifying the first block of the permissible forked blockchain, represented here as the fork root block 444 for the valid forked blockchain. The fork root block 444 of the forked blockchain is then followed by standard blocks, each having a header based on a prior valid block's hash, and will continue indefinitely.

Under normal operating conditions, even conventional blockchains naturally fork from time to time, however, with previously known blockchains, ultimately only a single branch may form the primary consensus chain and all other forks must be ignored or truncated with only the primary consensus blockchain being considered as valid. Consensus on which chain is valid may be achieved by choosing the longest chain, which thus represents the blockchain having the most work put into completing it. Therefore, it is necessary to utilize the fork block 443 as described herein to permit permissibly forked chains to be created and certified as authorized forks via the fork hash 449 so as to prevent participating nodes to ignore or truncate the fork. Because each node may independently validate the forked blockchain, it will not be ignored, just as a validated primary blockchain will not be ignored upon having consensus.

According to yet other embodiments, consumer supplied or manufacturer supplied data may be provisioned onto blockchain 401 to contribute payload data via an appropriate interface, such as the Web UI with HTML interface described above (refer to element 381 at FIG. 3B). The platform for zero plastic pollution 400 may serve as an interface for multiple inputs into a single asset on the blockchain. The interface may operate as a lightweight interface that allows consumers, manufacturers, retailers, shippers, government entities, and other participating “actors” to contribute information directly to the platform for zero plastic pollution 400. According to certain embodiments, electronic equipment such as Point of Sale (POS) terminals, cameras, sensors, RFID tag processors, etc., may be turned into Internet of things (IoT) objects through embedded sensors that connects to the platform for zero plastic pollution 400 and contributes data to the blockchain.

As previously described blockchain allows for data encryption and security. Data can not only be contributed directly onto the blockchain via a connected app (e.g., which is communicably interfaced with the receive interface of the system described below), but data may be tracked and traced to provide an audit trail of contribution and usage transparency. Public and private keys allow for the secure contribution of data from the various actors and for the cryptographic sealing of data for sharing only with approved users.

FIG. 5 depicts the S2 Geometry library for spherical geometry and the interplanetary file system (IPFS) to create a discrete global grid, to build a geographic database, in accordance with the described embodiments.

In accordance with described embodiments, the platform for zero plastic pollution implements information inventory systems and ranking of resource and commodity flows. Many systems in real life are complex, and this means that their time-dependent state changes are nonlinear. For instance, as is depicted here, the inflow rate λ(t) and discharge rate μ(t) often have a dynamic component, and this makes them more unpredictable in nature. In order to minimize queues and costs, it is useful to track these values.

The graphs that follow illustrate these methodologies in greater detail.

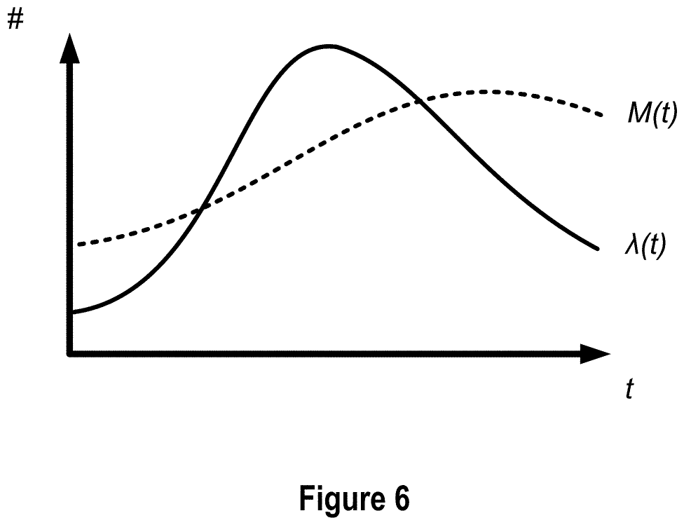

FIG. 6 plots λ(t) and M(t) (inflow lambda and outflow mu) on a time-number graph in accordance with the described embodiments. As is depicted here, both λ(t) and M(t) are plotted on a time-number graph.

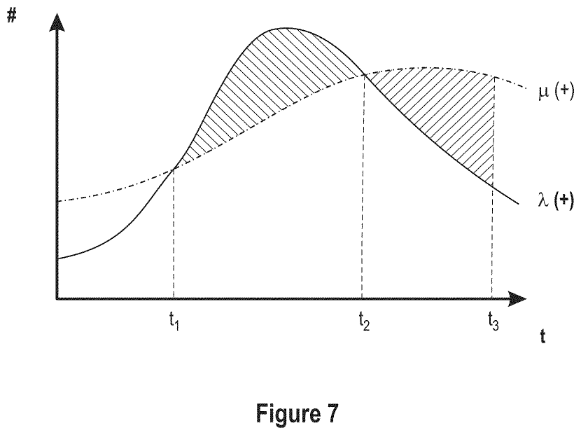

FIG. 7 plots, at time t_1 a queue begins to form, at t_2 a queue length is longest, and at t_3 a queue dissipates, in accordance with the described embodiments.

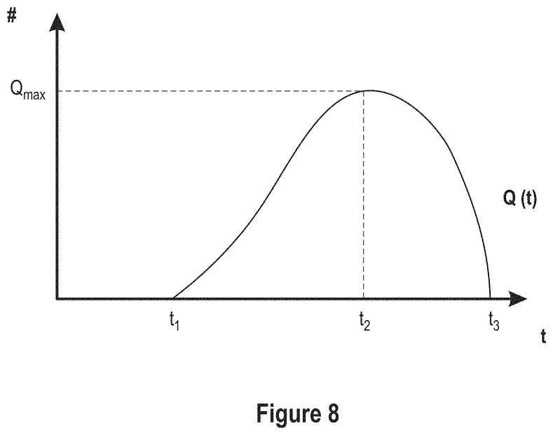

FIG. 8 plots Qmax (Q(t)) as a function of time, in accordance with the described embodiments.

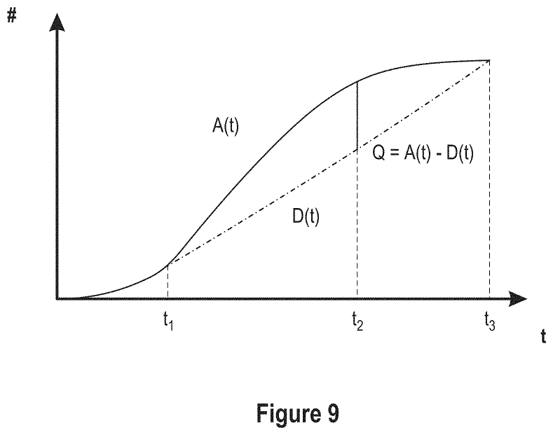

FIG. 9 plots both A(t) and D(t) as a function of time, where Q is equal to A(t) minus D(t), in accordance with the described embodiments.

Comparing FIG. 7 with FIG. 8, it may be observed that by taking the area between the two curves, the queue can be plotted, or accumulation of plastics on a time-number axis, with Q_max at time t_2.

After obtaining data, embodiments plot inflow rate λ(t) and outflow rate μ(t) on a time-number axis. From those inputs, embodiments perform analysis on a QODIC model. First, embodiments determine where inflow rate λ(t) first exceeds outflow rate μ(t) and label that point t_1. This is where the queue begins to form, that is, where congestion begins. The length of the queue from this point onwards is the area inflow rate λ(t)—outflow rate μ(t) from t_1 to any point tin the domain t_1 to t_3. Mathematically, this is expressed in equation 1 (refer to element 101 at FIG. 1). Using that same logic, embodiments identify the queue is at its maximum at the point where the outflow rate μ(t) begins to surpass the inflow rate μ(t). That point is labeled t_2.

From t_2 onwards, the queue becomes shorter, because outflow is greater than inflow. The queue completely dissipates at time t_3. Mathematically, this is expressed in equation 2 (refer to element 102 at FIG. 1). Geometrically, the area between inflow λ(t) and outflow μ(t) from t_1 to t_2 is equal to the area between outflow μ(t) and inflow λ(t) from t_2 to t_3. Mathematically, this is expressed in equation 3 (refer to element 103 at FIG. 1).

The area of the shaded region from t_1 to t_2 is the same as the area of the shaded region from t_2 to t_3. The goal is to reach time t_3 as soon as possible, which may be referred to as goal P0 (P-zero), when net plastic accumulation is zero, according to embodiments of the invention. Importantly, embodiments determine the congestion in a region at any given time and can predict the return period, or when the system defaults. Applied to plastic, embodiments can tell researchers how much litter is estimated to be present within a particular region, and also when there is no more litter expected to be remaining.

Embodiments of the invention contemplate a reward system for proactive actions. Such a reward system may be applied to facilities that do well with their management of plastics. Embodiments calculate an “EcoMetric” cumulative score that indicates environmental-friendly policies in the business sector. The score takes into account many factors, for example, the amount of plastic packaging a certain producer, retailer, or plastics manufacturer consumes in the course of a year. The score may also be specific to the industry and type of producer they identify as, i.e., restaurant, grocery store, retail store, packaging facility. Each industry or sector has a different baseline or requirement for certifications that can be presented to the business, thus acting as an incentive for the business sector to improve the packaging processes. This is because each sector of industry has different packaging needs, so it would not be fair to evaluate a grocery store and a retail store on the sole basis of packaging produced. The EcoMetric would tell a lot about a particular producer's environmental friendliness, for example, in terms of packaging.

In such a way, not only can certificates be awarded to stores that meet certain requirements, but awards could also be given to producers that are determined to have greatly improved their plastic consumption over the course of a year. The EcoMetric ideally is a continuous program. For instance, the calculated EcoMetric cumulative score allows tracking improvements in plastic usage over time according to such embodiments. Moreover, the EcoMetric cumulative score may also serve as an indicator to the public so as to represent how environmentally friendly a particular company is, thereby allowing consumers to be more involved in the process by choosing which stores to shop at and support at least partially on the basis of environmentally friendly policies and behaviors.

Embodiments of the invention contemplate a goal of P0 (Plastic-zero). Ultimately, the end goal is to get cities and businesses to change their behavior sufficiently that net plastic accumulation overall will be zero, that is to say, no plastic pollution or littering is accumulating within the environment.

Intermediate or incremental goals would be to reach a net plastic accumulation of P5 or P25, according to embodiments of the invention, thus showing progress toward the ultimate goal of P0 plastic pollution.

FIG. 10 illustrates a diagrammatic representation of a machine 1001 in the exemplary form of a computer system, in accordance with one embodiment, within which a set of instructions, for causing the machine/computer system 1001 to perform any one or more of the methodologies discussed herein, may be executed. In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set top box (STB), a Personal Digital Assistant (PDA), a cellular telephone, a web appliance, a server, a network router, switch or bridge, computing system, or any machine capable of executing a set of instructions (sequential or otherwise) that specify and mandate the specifically configured actions to be taken by that machine pursuant to stored instructions. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1001 includes a processor 1002, a main memory 1004 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 1018 (e.g., a persistent storage device including hard disk drives and a persistent database and/or a multi-tenant database implementation), which communicate with each other via a bus 1030. Main memory 1004 includes a blockchain services interface 1024 via which the platform for zero plastic pollution and its systems, functions, AI models, and various methodologies may interact with either an IPFS file system, a DLT platform, or a specially configured blockchain, in support of the described embodiments. Main memory further 1004 includes a blockchain consensus manager 1023 and a block validator 1025 via which node participants, actors, data contributors, data consumers, and the platform for zero plastic pollution may interact with the blockchain or other specially configured systems to perform validation services, contribute to consensus, or otherwise validate incoming and outgoing information. Main memory 1004 and its sub-elements are further operable in conjunction with processing logic 1026 and processor 1002 to perform the methodologies discussed herein.

Processor 1002 represents one or more specialized and specifically configured processing devices such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1002 may also be one or more special-purpose processing devices such as an application specific integrated circuit (ASIC), a field programmable gate array (FPGA), a digital signal processor (DSP), network processor, or the like. Processor 1002 is configured to execute the processing logic 1026 for performing the operations and functionality which is discussed herein.

The computer system 1001 may further include a network interface card 1008. The computer system 1001 also may include a user interface 1010 (such as a video display unit, a liquid crystal display, etc.), an alphanumeric input device 1012 (e.g., a keyboard), a cursor control device 1013 (e.g., a mouse), and a signal generation device 1016 (e.g., an integrated speaker). The computer system 1001 may further include peripheral device 1036 (e.g., wireless or wired communication devices, memory devices, storage devices, audio processing devices, video processing devices, etc.).

The secondary memory 1018 may include a non-transitory machine-readable storage medium or a non-transitory computer readable storage medium or a non-transitory machine-accessible storage medium 1031 on which is stored one or more sets of instructions (e.g., software 1022) embodying any one or more of the methodologies or functions described herein. The software 1022 may also reside, completely or at least partially, within the main memory 1004 and/or within the processor 1002 during execution thereof by the computer system 1000, the main memory 1004 and the processor 1002 also constituting machine-readable storage media. The software 1022 may further be transmitted or received over a network 1020 via the network interface card 1008.

According to a particular embodiment, there is a system for tracking plastic consumption, in which the system includes: a memory to store instructions; a processor to execute instructions stored in the memory; and stored logic within the memory that, when executed by the processor, causes the processor to perform operations including: exposing a receive interface to a plurality of market actors having plastics consumption information; receiving input data at the receive interface from the plurality of market actors specifying the plastics consumption information for each of the plurality of market actors; receiving a specified level of geographic region specificity, selected by each of the market actors specifying the plastics consumption information and correlating the received plastics consumption information received from each market actor to the specified level of geographic region specificity selected by each respective market actor; in which the received plastics consumption information and the correlated specified level of geographic region for each respective market actor is persistently stored in an encrypted format via a distributed storage system via the received interface exposed to the market actors; extracting and decrypting the plastics consumption information from the distributed storage system to determine plastic consumption inflow rates and plastic consumption outflow rates for a specific geographic region across a subset of the plurality of market actors; executing instructions via the processor of the platform to analyze an inflow and outflow rate of plastics usage for the specified geographic region based on the determined plastic consumption inflow rates and plastic consumption outflow rates; and outputting an estimated time to zero plastic pollution and a calculated score rating plastics usage in the specified geographic region for each of the plurality of market actors in the subset corresponding to the specified geographic region.

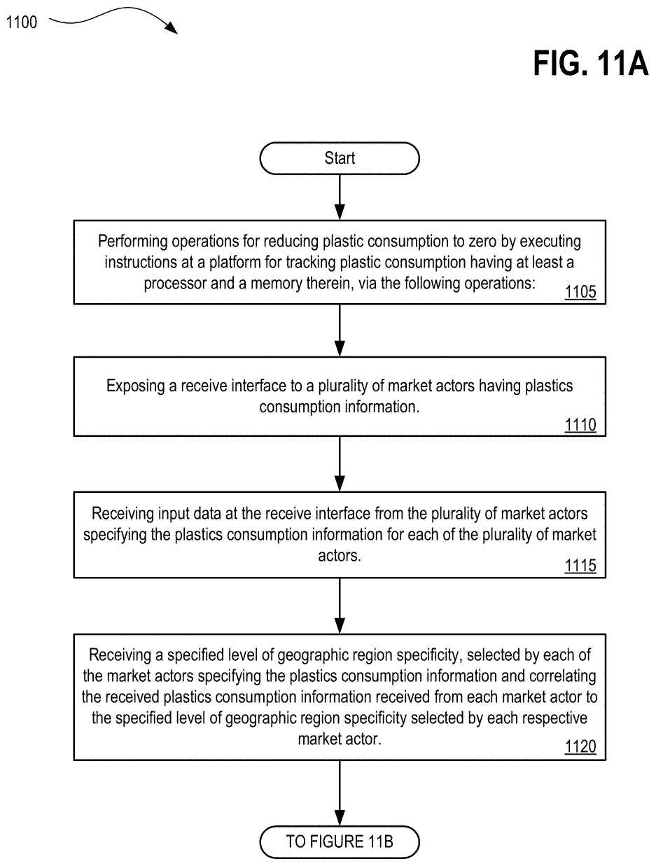

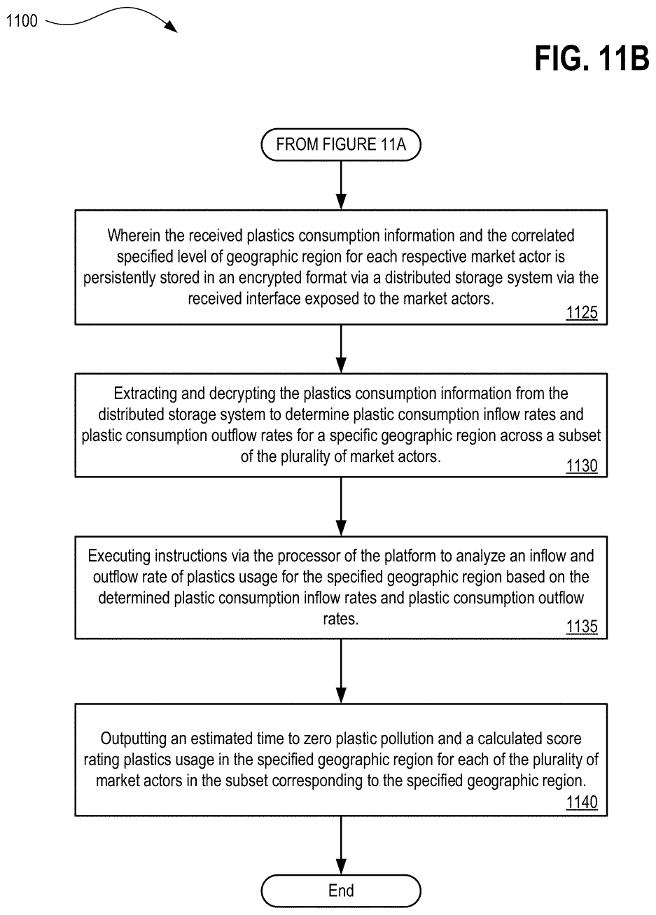

FIGS. 11A-11B depicts a flow diagram illustrating a method 1100 for implementing data collection, analysis, and a reward system for zero plastic pollution, in accordance with disclosed embodiments.

Method 1100 may be performed by processing logic that may include hardware (e.g., circuitry, dedicated logic, programmable logic, microcode, etc.), software (e.g., instructions run on a processing device) to perform various operations such as designing, defining, retrieving, parsing, persisting, exposing, loading, executing, operating, receiving, generating, storing, maintaining, creating, returning, presenting, interfacing, communicating, transmitting, querying, processing, providing, determining, triggering, displaying, updating, sending, etc., in pursuance of the systems and methods as described herein. For example, machine 1001 (see FIG. 10) and the other supporting systems and components as described herein may implement the described methodologies. Some of the blocks and/or operations listed below are optional, in accordance with certain embodiments. The numbering of the blocks presented is for the sake of clarity and is not intended to prescribe an order of operations in which the various blocks must occur.

With reference to the method 1100 depicted at FIG. 11A beginning at block 1105, there is a method performed by a platform for tracking plastic consumption. Specifically, processing logic performs operations for reducing plastic consumption to zero by executing instructions at the platform for tracking plastic consumption having at least a processor and a memory therein, via the operations that follow.

At block 1110, processing logic exposes a receive interface to a plurality of market actors having plastics consumption information.

At block 1115, processing logic receives input data at the receive interface from the plurality of market actors specifying the plastics consumption information for each of the plurality of market actors.

At block 1120, processing logic receives a specified level of geographic region specificity, selected by each of the market actors specifying the plastics consumption information and correlating the received plastics consumption information received from each market actor to the specified level of geographic region specificity selected by each respective market actor.

Method 1100 continues at FIG. 11B.

With reference to the method 1100 as depicted at FIG. 11B beginning at block 1125, the received plastics consumption information and the correlated specified level of geographic region for each respective market actor is persistently stored in an encrypted format via a distributed storage system via the received interface exposed to the market actors.

At block 1130, processing logic extracts and decrypts the plastics consumption information from the distributed storage system to determine plastic consumption inflow rates and plastic consumption outflow rates for a specific geographic region across a subset of the plurality of market actors.

At block 1135, processing logic executes instructions via the processor of the platform to analyze an inflow and outflow rate of plastics usage for the specified geographic region based on the determined plastic consumption inflow rates and plastic consumption outflow rates.

At block 1140, processing logic outputs an estimated time to zero plastic pollution and a calculated score rating plastics usage in the specified geographic region for each of the plurality of market actors in the subset corresponding to the specified geographic region.

According to another embodiment of method 1100, outputting the calculated score includes outputting an EcoMetric cumulative score for each of the plurality of market actors by industry category, in which each EcoMetric cumulative score indicates environmentally friendliness on a numerical scale for a particular company.

According to another embodiment, method 1100 further includes: calculating a cumulative score that indicates environmental-friendly policies in a business sector, in which the cumulative score takes into account one or more factors selected from a group consisting of: an amount of plastic packaging a certain producer consumes in the course of a year, a score specific to the industry of a producer, and a score specific to a type of producer.

According to another embodiment of method 1100, analyzing the inflow and outflow rate includes plotting λ(t) as inflow lambda and μ(t) as outflow mu on a time-number graph to determine an accumulation of plastics in the specified geographic region based on an area between two curves resulting from the plotting of the inflow and outflow rates.

According to another embodiment of method 1100, analyzing the inflow and outflow rate includes plotting λ(t) as inflow lambda and μ(t) as outflow mu on a time-number graph to determine an estimated time to reach P0, representing zero plastic accumulation for the specified geographic region.

According to another embodiment of method 1100, receiving input data from the plurality of sources regarding geographic-based plastics usage, each source choosing a level of specificity regarding the geographic-based plastics usage, includes receiving input from a plurality of spatially distributed sources, each of varying geographic region resolutions.

According to another embodiment of method 1100, persistently storing via a distributed storage system includes persistently storing the received plastics consumption information and the correlated specified level of geographic region for each respective market actor via one of: an interplanetary file system (IPFS) protocol based storage platform; a Distributed Ledger Technology protocol based storage platform; and a blockchain accessible to the plurality of market actors via the receive interface.

According to another embodiment of method 1100, analyzing an inflow and outflow rate of plastics usage for a geographic region based on the encrypted received data includes analyzing a number of plastic bags that enter and exit a geographic region; and storing the analyzed number of plastic bags that enter and exit a geographic region in the distributed storage system.

According to another embodiment, method 1100 further includes: assigning a unique identifier for each type of plastic bag that enters and exits a geographic region; and tracking each analyzed number of plastic bags that enter and exit a geographic region based on the respective unique identifier.

According to another embodiment of method 1100, analyzing the inflow and outflow rate of plastics usage for a geographic region based on the encrypted received data includes analyzing the inflow and outflow rate of plastics usage for the geographic region according to a temporal level specifying a rate of plastic bag distribution per day, per month, per year or according to a geographical level such as plastic bag use per facility, per state, per country.

According to another embodiment of method 1100, analyzing the inflow and outflow rate of plastics usage for a geographic region based on the encrypted received data includes plotting on a time-number graph the inflow rate and outflow rate of plastics usage for the geographic region based on the encrypted received data by the following operations: (i) plotting an inflow rate λ(t) and an outflow rate μ(t) on a time-number axis; (ii) determining where the inflow rate λ(t) first exceeds the outflow rate μ(t) and labeling that point t_1, which is where a queue begins to form, that is, where congestion begins; (ii) determining where the queue is at its maximum at the point where the outflow rate μ(t) begins to surpass the inflow rate λ(t), and labeling that point t_2; and (iv) determining where the queue dissipates and labeling that point t_3.

According to another embodiment, method 1100 further includes: generating one or more goals for plastics usage for the specified geographic region based on the analyzed data; and publishing the generated goals for plastics usage.

According to a particular embodiment, there is a non-transitory computer readable storage medium having instructions stored thereupon that, when executed by a plastics tracking platform having at least a processor and a memory therein, the instructions cause the plastics tracking platform to perform operations including: exposing a receive interface to a plurality of market actors having plastics consumption information; receiving input data at the receive interface from the plurality of market actors specifying the plastics consumption information for each of the plurality of market actors; receiving a specified level of geographic region specificity, selected by each of the market actors specifying the plastics consumption information and correlating the received plastics consumption information received from each market actor to the specified level of geographic region specificity selected by each respective market actor; in which the received plastics consumption information and the correlated specified level of geographic region for each respective market actor is persistently stored in an encrypted format via a distributed storage system via the received interface exposed to the market actors; extracting and decrypting the plastics consumption information from the distributed storage system to determine plastic consumption inflow rates and plastic consumption outflow rates for a specific geographic region across a subset of the plurality of market actors; executing instructions via the processor of the platform to analyze an inflow and outflow rate of plastics usage for the specified geographic region based on the determined plastic consumption inflow rates and plastic consumption outflow rates; and outputting an estimated time to zero plastic pollution and a calculated score rating plastics usage in the specified geographic region for each of the plurality of market actors in the subset corresponding to the specified geographic region.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A system for tracking plastic consumption, wherein the system comprises:
a memory to store instructions;
a processor to execute instructions stored in the memory; and
stored logic within the memory that, when executed by the processor, causes the processor to perform operations including:
exposing a receive interface to a plurality of market actors having plastics consumption information;
receiving input data at the receive interface from the plurality of market actors specifying the plastics consumption information for each of the plurality of market actors;
receiving a specified level of geographic region specificity, selected by each of the market actors specifying the plastics consumption information and correlating the received plastics consumption information received from each market actor to the specified level of geographic region specificity selected by each respective market actor;
wherein the received plastics consumption information and the correlated specified level of geographic region for each respective market actor is persistently stored in an encrypted format via a distributed storage system via the received interface exposed to the market actors;
extracting and decrypting the plastics consumption information from the distributed storage system to determine plastic consumption inflow rates and plastic consumption outflow rates for a specific geographic region across a subset of the plurality of market actors;
executing instructions via the processor of the platform to analyze an inflow and outflow rate of plastics usage for the specified geographic region based on the determined plastic consumption inflow rates and plastic consumption outflow rates; and
outputting an estimated time to zero plastic pollution and a calculated score rating plastics usage in the specified geographic region for each of the plurality of market actors in the subset corresponding to the specified geographic region.

2. The system of claim 1, wherein outputting the calculated score includes outputting an EcoMetric cumulative score for each of the plurality of market actors by industry category, in which each EcoMetric cumulative score indicates environmentally friendliness on a numerical scale for a particular company.

3. The system of claim 1, further comprising:
calculating a cumulative score that indicates environmental-friendly policies in a business sector, in which the cumulative score takes into account one or more factors selected from a group consisting of: an amount of plastic packaging a certain producer consumes in the course of a year, a score specific to the industry of a producer, and a score specific to a type of producer.

4. The system of claim 1, wherein analyzing the inflow and outflow rate includes plotting λ(t) as inflow lambda and μ(t) as outflow mu on a time-number graph to determine an accumulation of plastics in the specified geographic region based on an area between two curves resulting from the plotting of the inflow and outflow rates.

5. The system of claim 1, wherein analyzing the inflow and outflow rate includes plotting λ(t) as inflow lambda and μ(t) as outflow mu on a time-number graph to determine an estimated time to reach P0, representing zero plastic accumulation for the specified geographic region.

6. The system of claim 1, wherein receiving input data from the plurality of sources regarding geographic-based plastics usage, each source choosing a level of specificity regarding the geographic-based plastics usage, includes receiving input from a plurality of spatially distributed sources, each of varying geographic region resolutions.

7. The system of claim 1, wherein analyzing persistently storing via a distributed storage system includes persistently storing the received plastics consumption information and the correlated specified level of geographic region for each respective market actor via one of: an interplanetary file system (IPFS) protocol based storage platform; a Distributed Ledger Technology protocol based storage platform; and a blockchain accessible to the plurality of market actors via the receive interface.

8. The system of claim 1, wherein analyzing an inflow and outflow rate of plastics usage for a geographic region based on the encrypted received data includes:
analyzing a number of plastic bags that enter and exit a geographic region; and
storing the analyzed number of plastic bags that enter and exit a geographic region in the distributed storage system.

9. The system of claim 1, further comprising:
assigning a unique identifier for each type of plastic bag that enters and exits a geographic region; and tracking each analyzed number of plastic bags that enter and exit a geographic region based on the respective unique identifier.

10. The system of claim 1, wherein analyzing the inflow and outflow rate of plastics usage for a geographic region based on the encrypted received data includes analyzing the inflow and outflow rate of plastics usage for the geographic region according to a temporal level specifying a rate of plastic bag distribution per day, per month, per year or according to a geographical level such as plastic bag use per facility, per state, per country.

11. The system of claim 1, wherein analyzing the inflow and outflow rate of plastics usage for a geographic region based on the encrypted received data includes plotting on a time-number graph the inflow rate and outflow rate of plastics usage for the geographic region based on the encrypted received data by the following operations:
(i) plotting an inflow rate λ(t) and an outflow rate μ(t) on a time-number axis;
(ii) determining where the inflow rate λ(t) first exceeds the outflow rate μ(t) and labeling that point t_1, which is where a queue begins to form, that is, where congestion begins;
(ii) determining where the queue is at its maximum at the point where the outflow rate μ(t) begins to surpass the inflow rate λ(t), and labeling that point t_2; and
(iv) determining where the queue dissipates and labeling that point t_3.

12. The system of claim 1, further comprising:
generating one or more goals for plastics usage for the specified geographic region based on the analyzed data; and publishing the generated goals for plastics usage.

13. A computer-implemented method performed by a platform for tracking plastic consumption having at least a processor and a memory therein, therein the computer-implemented method comprises:
exposing a receive interface to a plurality of market actors having plastics consumption information;
receiving input data at the receive interface from the plurality of market actors specifying the plastics consumption information for each of the plurality of market actors;
receiving a specified level of geographic region specificity, selected by each of the market actors specifying the plastics consumption information and correlating the received plastics consumption information received from each market actor to the specified level of geographic region specificity selected by each respective market actor;
wherein the received plastics consumption information and the correlated specified level of geographic region for each respective market actor is persistently stored in an encrypted format via a distributed storage system via the received interface exposed to the market actors;
extracting and decrypting the plastics consumption information from the distributed storage system to determine plastic consumption inflow rates and plastic consumption outflow rates for a specific geographic region across a subset of the plurality of market actors;
executing instructions via the processor of the platform to analyze an inflow and outflow rate of plastics usage for the specified geographic region based on the determined plastic consumption inflow rates and plastic consumption outflow rates; and
outputting an estimated time to zero plastic pollution and a calculated score rating plastics usage in the specified geographic region for each of the plurality of market actors in the subset corresponding to the specified geographic region.

14. The computer-implemented method of claim 13, wherein outputting the calculated score comprises outputting an EcoMetric cumulative score for each of the plurality of market actors by industry category, wherein each EcoMetric cumulative score indicates environmentally friendliness on a numerical scale for a particular company.

15. The computer-implemented method of claim 13, wherein the stored logic is specially configured to cause the system to perform further operations, comprising:
calculating a cumulative score that indicates environmental-friendly policies in a business sector, wherein the cumulative score takes into account one or more factors selected from a group consisting of: an amount of plastic packaging a certain producer consumes in the course of a year, a score specific to the industry of a producer, and a score specific to a type of producer.

16. The computer-implemented method of claim 13, wherein analyzing the inflow and outflow rate comprises plotting λ(t) as inflow lambda and μ(t) as outflow mu on a time-number graph to determine an accumulation of plastics in the specified geographic region based on an area between two curves resulting from the plotting of the inflow and outflow rates.

17. The computer-implemented method of claim 13, wherein analyzing the inflow and outflow rate comprises plotting λ(t) as inflow lambda and μ(t) as outflow mu on a time-number graph to determine an estimated time to reach P0, representing zero plastic accumulation for the specified geographic region.

18. Non-transitory computer-readable storage media having instructions stored thereupon that, when executed by a plastics tracking platform having at least a processor and a memory therein, the instructions cause the plastics tracking platform to perform operations including:
exposing a receive interface to a plurality of market actors having plastics consumption information;
receiving input data at the receive interface from the plurality of market actors specifying the plastics consumption information for each of the plurality of market actors;
receiving a specified level of geographic region specificity, selected by each of the market actors specifying the plastics consumption information and correlating the received plastics consumption information received from each market actor to the specified level of geographic region specificity selected by each respective market actor;
wherein the received plastics consumption information and the correlated specified level of geographic region for each respective market actor is persistently stored in an encrypted format via a distributed storage system via the received interface exposed to the market actors;
extracting and decrypting the plastics consumption information from the distributed storage system to determine plastic consumption inflow rates and plastic consumption outflow rates for a specific geographic region across a subset of the plurality of market actors;
executing instructions via the processor of the platform to analyze an inflow and outflow rate of plastics usage for the specified geographic region based on the determined plastic consumption inflow rates and plastic consumption outflow rates; and
outputting an estimated time to zero plastic pollution and a calculated score rating plastics usage in the specified geographic region for each of the plurality of market actors in the subset corresponding to the specified geographic region.

19. The non-transitory computer-readable storage media of claim 18, wherein outputting the calculated score comprises outputting an EcoMetric cumulative score for each of the plurality of market actors by industry category, wherein each EcoMetric cumulative score indicates environmentally friendliness on a numerical scale for a particular company.

20. The non-transitory computer-readable storage media of claim 18, wherein analyzing the inflow and outflow rate comprises:
plotting λ(t) as inflow lambda and μ(t) as outflow mu on a time-number graph to determine an accumulation of plastics in the specified geographic region based on an area between two curves resulting from the plotting of the inflow and outflow rates; and
plotting λ(t) as inflow lambda and μ(t) as outflow mu on a time-number graph to determine an estimated time to reach P0, representing zero plastic accumulation for the specified geographic region.
